(19) United States
(12) Patent Application Publication
(10) Pub. No.: US 2004/0181611 A1
(43) Pub. Date: Sep. 16, 2004

(54) Multimedia streaming system for wireless handheld devices

(76) Inventor: Viresh Ratnakar, Sunnyvale, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/390,130

(22) Filed: Mar. 14, 2003

(51) Int. Cl. G06F 15/16

(52) U.S. Cl. 709/250; 709/231; 709/219

(57) ABSTRACT

A client capable of displaying received video data is provided. The client includes a network input/output (IO) component configured to receive video data and transmit requests for video data to a server. The scheduled-thread component is configured to decode and display the video data. The reader-thread component is configured to obtain the video data through the network IO. The reader-thread component further configured to supply the scheduled-thread component with the received video data from a buffer associated with the reader-thread component. A system for streaming video/audio data, a method for communicating video/audio data between a server and a client and a computer readable medium are also included.

### BACKGROUND OF THE INVENTION

1. Field of the Invention

This invention relates generally to multimedia streaming and more particularly to a system configured to accommodate a client/server configuration for exchanging audio/video streams within the low power constraints characteristic of wireless handheld devices.

2. Description of the Related Art

Portable electronic devices are continually being enhanced to perform more functionality. Wireless networking has expanded the capabilities and appeal for these devices. For example, cell phones are available with color display screens and may be used to play games which may be downloaded from a server through a wireless network. Because of the constrained resources of portable electronic devices, e.g., power and memory constraints, a two way point-to-point streaming protocol must be configured to operate within the constraints associated with the portable electronic devices.

FIG. 1 is a simplified schematic diagram of a client/server relationship across a wireless network. Server 100 communicates data to client 104 across network 102. Streaming protocols tend to place the responsibility on both sever 100 and client 104 when an exception happens. For example, if client 104 does not receive packets sent by server 100, then the client and the server communicate to re-transmit the packets. Server 100 maintains the states of each of the clients, therefore, the server determines which packets to send according to the state of the client maintained by the server. Maintaining the states of each of the clients reduces the amount of clients that server 100 can support. More specifically, the maintenance of the states by the server consumes computational power that may otherwise be utilized to serving additional clients. Accordingly, as more clients are served, more computational power is required for maintaining the states. In addition, the communication protocols used for transporting data across the networks are not configured to accommodate the low power requirements for battery operated devices. For example, the communication protocols, such as the Transmission Control protocol (TCP) where delivery is guaranteed, is wasteful for the bursty characteristics associated with wireless networking. Furthermore, the communication protocols tend to not be accommodating for the moderate amounts of memory available for wireless handheld devices.

As a result, there is a need to solve the problems of the prior art to provide a communication protocol configured to accommodate the constraints characteristic of handheld electronic devices.

### SUMMARY OF THE INVENTION

Broadly speaking, the present invention fills these needs by providing a streaming protocol targeted to accommodate the constraints of handheld electronic devices. It should be appreciated that the present invention can be implemented in numerous ways, including as a method, a system, computer readable media or a device. Several inventive embodiments of the present invention are described below.

In one embodiment, a system configured to support multimedia streaming is provided. The system includes a client and a server. The client is associated with a reader-thread component and a scheduled-thread component. The reader-thread component is associated with a buffer for storing data received by the client. The reader-thread component is further configured to perform network input/output functionality. The scheduled-thread component enables decoding and displaying a multimedia stream of data. The scheduled-thread component is further configured to obtain access units from the buffer. The server is in communication with the client through a network and the server is configured to transmit access units specified by the client to the client.

In another embodiment, a system for streaming digital video/audio data is provided. The system includes a client configured to maintain a state of the client. The system also includes a server in communication with the client through a network. A User Datagram Protocol (UDP) enables communication between the client and the server through the network. The UDP protocol defines a packet configured to hold at least one access unit (AU). Each of the AUs represent one frame of video/audio data. The frame of video/audio data is transmitted to the client from the server. The transmission of the frame of data being initiated by transmission of a send packet from the client to the server based upon the state maintained by the client. In response to receiving the send packet, the server transmits the frame of video data specified in the send packet.

In yet another embodiment, a client capable of displaying received video data is provided. The client includes a network input/output (IO) component configured to receive video data and transmit requests for video data to a server. The scheduled-thread component is configured to decode and display the video data. The reader-thread component is configured to obtain the video data through the network IO. The reader-thread component further configured to supply the scheduled-thread component with the received video data from a buffer associated with the reader-thread component.

In still yet another embodiment, a method for communicating video/audio data from a server to a client is provided. The method initiates with transmitting a call from the client to the server to identify a streaming session. Then in response to receiving the call from the client, an initial object descriptor (IOD) is transmitted from the server to the client. Next, data transfer is initiated in response to receiving the IOD. The initiating of the data transfer includes, communicating data indicating both a start sequence of streaming session data and an amount of the streaming session data to the server. The start sequence and the amount of the streaming session data are determined by the client. Then, the server responds to the receipt of the data indicating the start sequence and the amount of the streaming session data by supplying the client with the access units containing the video/audio data.

In another embodiment, a computer readable medium having program instructions for communicating video/audio data from a server to a client is provided. The computer readable medium includes program instructions for transmitting a call from the client to the server to identify a streaming session and program instructions for transmitting an initial object descriptor (IOD) from the server to the client in response to receiving the call from the client. Program instructions for initiating data transfer in response to receiving the IOD are included. The program instructions for initiating data transfer include program instructions for communicating data indicating both a start sequence of streaming session data and an amount of the streaming session data to the server, the start sequence and the amount being determined by the client. Program instructions for responding to the receipt of the data indicating the start sequence and the amount of the streaming session data by supplying the client with access units containing the video/audio data are also included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram of a client/server relationship across a wireless network.

FIG. 2 is a simplified schematic diagram of a client server relationship incorporating a streaming protocol configured to accommodate the unique constraints and characteristics for low power hand-held devices in accordance with one embodiment of the invention.

FIG. 3 is a simplified schematic diagram of a user datagram protocol (UDP) packet including video/audio data in accordance with one embodiment of the invention.

FIG. 4 is a simplified schematic diagram illustrating the configuration of a request from a client to a server for sending packet data to the client in accordance with one embodiment of the invention.

FIG. 5 is a simplified schematic diagram representing the configuration of a client in accordance with one embodiment of the invention.

FIG. 6 is a flow chart diagram illustrating the method operations for the algorithm used in the scheduled-thread in accordance with one embodiment of the invention.

FIG. 7 is a flow chart diagram illustrating the method operations for a process function invoked periodically by the reader-thread in accordance with one embodiment of the invention.

FIG. 8 is a flow chart diagram illustrating the method operations for communicating video/audio data from a server to a client in accordance with one embodiment of the invention.

### DETAILED DESCRIPTION OF THE PREFERRED EMBODIMENTS

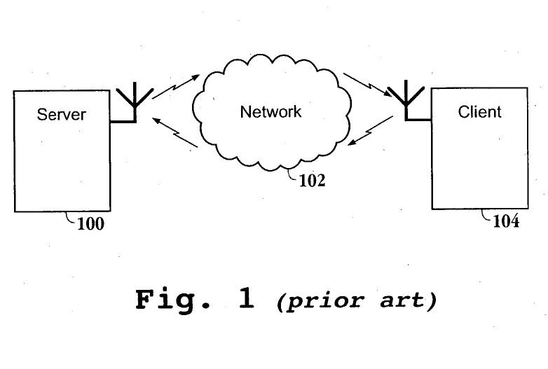

An invention is described for a system configured to support multimedia streaming for two-way point-to-point streaming from a sending unit to a receiving unit. However, it will become apparent to one skilled in the art, that the present invention may be practiced without some or all of these specific details. In other instances, well known process operations have not been described in detail in order not to unnecessarily obscure the present invention. FIG. 1 is described in the “Background of the Invention” section. The term about as used to herein refers to +/−10% of the referenced value.

The embodiments of the present invention provide a system and a communication protocol for the transfer of data between a client and a server. As used herein, a client refers to a device playing or displaying the data, e.g., a multimedia stream, and a server refers to a device sending the multimedia stream of data. It should be appreciated that in two-way point-to-point streaming, the two endpoints can both simultaneously act as a client and a server. The multimedia streaming protocol relates to digital video and audio in typical formats, e.g., Motion Picture Expert Group (MPEG)-4 standard. The communication protocol is further targeted for low power handheld devices. Exemplary low power handheld devices include cellular phones, personal digital assistants (PDA), pocket personal computers, web tablets, lap top computer, etc.

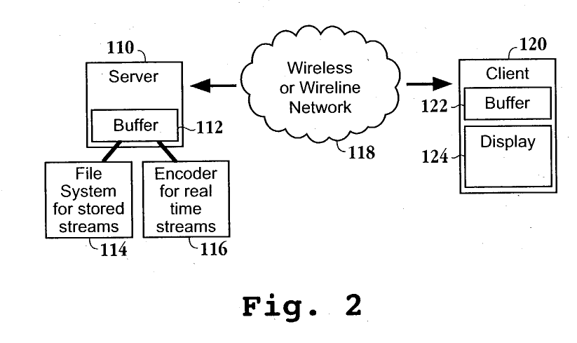

FIG. 2 is a simplified schematic diagram of a client server relationship incorporating a streaming protocol configured to accommodate the unique constraints and characteristics for low power hand-held devices in accordance with one embodiment of the invention. As mentioned above, in two way point-to-point streaming, the two end points can both simultaneously act as a client and server. Thus, both the server and the client have to be configured to live inside the low power hand-held devices. Server 110 is configured to serve a pre-existing stream from its file system 114 or it could be serving a stream generated by a real-time encoder 116 through buffer 112. The streaming data is transmitted over wireless or wire line network 118 to client 120. Client 120 includes buffer 122 in display screen 124. It should be appreciated that client 120 is in the best position to determine what is going on at the client. That is, the client can determine best whether there is a bad connection, what data is needed, how much capacity the client has, etc. Thus, the embodiments described herein take advantage of the client knowledge in that the client provides information to the server as to what is needed by the client rather than the server maintaining states for the client. Furthermore, the added computation on the client side does not come at a great expense. Consequently, it becomes advantageous for the server in not needing to keep states for each client as the server gains the capability to serve additional clients.

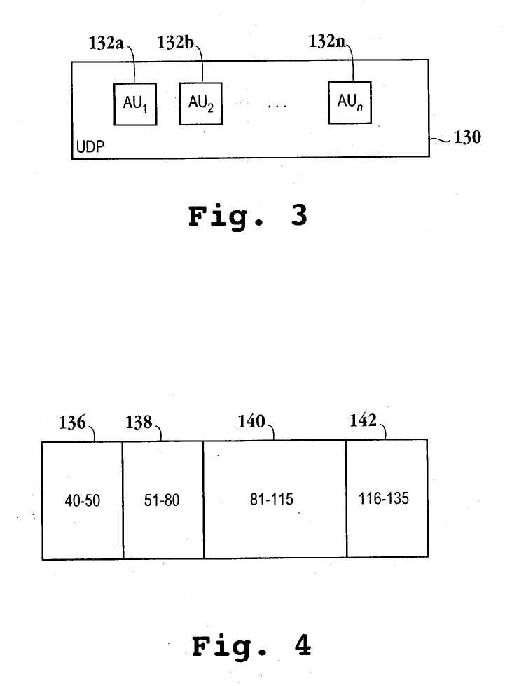

FIG. 3 is a simplified schematic diagram of a user datagram protocol (UDP) packet including video/audio data in accordance with one embodiment of the invention. UDP packet 130 includes access units (AU) 132a-132n containing image data. Here, AU₁ 132a, AU₂ 132b through AUₙ 132n each contain a frame of video/audio data. In one embodiment, the video/audio data is formatted in the MPEG-4 standard. In another embodiment, the size of UDP packet 130 is variable, however, the maximum packet size is 8192 bytes. The UDP protocol 130 allows 64 kilobytes of data to be incorporated into a packet, but typically the limit is lower in real networks. It should be appreciated that the streaming protocol described herein is targeted for low-bit rate video, i.e., 128 kilobits per second or lower. Thus, as the server does not maintain states for each of the clients, the client will initiate calls and specify the data to be transferred to the client. In response, the server sends the requested information as illustrated in UDP packet 130. Thus, by building the system described herein on top of a non-guaranteed delivery protocol, e.g., UDP, the burstiness characteristic of moving devices is better accommodated.

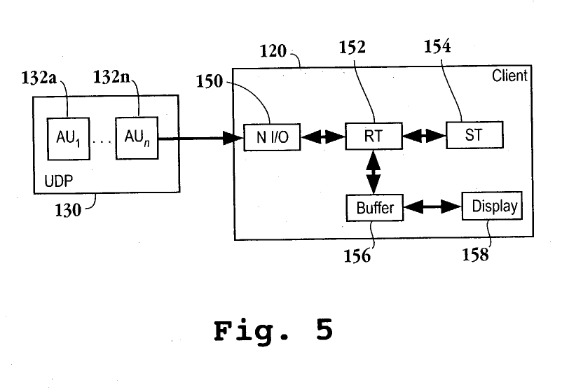

FIG. 4 is a simplified schematic diagram illustrating the configuration of a request from a client to a server for sending packet data to the client in accordance with one embodiment of the invention. In one embodiment, the request is included when the client initiates data transfer and then transmit a SEND packet to the server. The SEND packet indicates a start sequence number and also may indicate a skip list. For example, block 136 of FIG. 4 indicates a start sequence number of 40. As the client may already have data corresponding to regions 51-80 in block 138 and regions 116-135 in block 142, the SEND packet data may include a skip list. The skip list will indicate to send packets 40-50 specified in block 136 and 81-115 specified in block 140 while skipping packets 51-80 specified in block 138 and 116-135 specified in block 142.

In one embodiment, the various packets illustrated below are formatted with null terminated lines at the header. In this embodiment, after the last line, there will be two NULLs. For packets carrying data apart from protocol information in the header, such as the initial object descriptor (IOD) packet and the access units (AU) packet, the data always begins at a fixed offset. In one embodiment, the offset is 512 bytes. As seen below in TABLE 1, the various packets include OPEN packets, IOD packets, AU packets, SEND packets, and CLOSE packets. Accordingly, the protocol is simple in design and meets the goal of achieving flexibility without burdening the protocol with an overwhelming set of options. That is, the intelligence in the system lies with the client and the server and not the protocol. As is explained further below, the client chooses the values in the SEND packets and then the server chooses what to send in the access unit packets intelligently, i.e., based upon the constraints of the handheld devices.

TABLE 1
OPEN

session-id
stream-name

IOD

session-id

AU

session-id
[au-num offset]*

SEND

session-id
req-num
available slots
available-buff-in-bytes
start-seq-num
[skip-seq-num numToSkip]*

CLOSE

session-id

TABLE 1 includes the various types of packets along with the information that is obtained within each type of packet. The values in square brackets with an * in TABLE 1 indicate that zero or more of these values may be present, with separating NULLs. In one embodiment, the total number of skip lines indicated by the skip-seq-num numToSkip data of the SEND packet is less than a maximum number of skip lines set at 256. As mentioned above, for the IOD and AU packets the data begins at an offset set at 512 bytes in another embodiment.

FIG. 5 is a simplified schematic diagram representing the configuration of a client in accordance with one embodiment of the invention. Client 120 is configured to receive UDP packet 130 containing access units AU₁ 132a through AU₁ 132n. Network input/output block 150 receives the incoming UDP packet 130. Reader-thread block 152, also referred to as RT, is configured to perform the network input/output. Scheduled-thread block 154, also referred to as ST, is in communication with reader-thread block 152. Scheduled-thread block 154 is configured for decoding and displaying the video stream of data. In one embodiment, scheduled-thread block 154 asks reader-thread block 152 for the next access unit needed for displaying an image. If the access unit is in buffer 156, then the access unit is delivered to scheduled-thread 154 for decoding and eventual displaying on display screen 158. If the access unit is not in buffer 156 then the reader-thread block 152 uses a parameter referred to as preferbuffering. The preferbuffering parameter is a percentage indication of whether the user prefers not to miss any part of the stream at the expense of continuous playing with possibly skipped access units. Depending upon the value of the preferredbuffering parameter, as will be explained in more detail below, reader-thread block 152 will wait for a certain time to see if it can acquire the needed access unit. If reader-thread block 152 cannot obtain the needed data, the reader-thread will return empty data and the decoder's error concealment algorithms will provide data to fill in for the empty data.

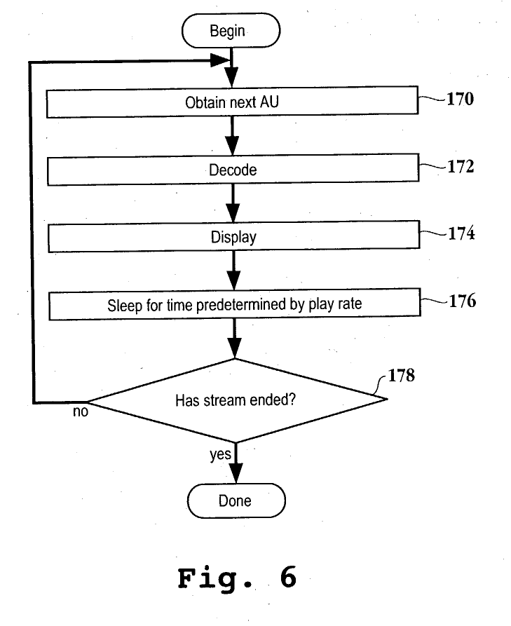

FIG. 6 is a flow chart diagram illustrating the method operations for the algorithm used in the scheduled-thread in accordance with one embodiment of the invention. The method initiates with operation 170 where the next access unit is obtained. In one embodiment, the next access unit is obtained from the buffer associated with the reader-thread. The method then advances to operation 172 where the video stream data is decoded and then in operation 174 the decoded video stream data is displayed. It should be appreciated that any suitable decoding algorithm can be used here. In one embodiment, the data contained in the access units is formatted in the Motion Picture Expert Group (MPEG)-4 format. From operation 174, the method proceeds to operation 176 where the scheduled-thread will sleep for a time pre-determined by a play rate. For example, if the play rate is 15 frames per second, the scheduled-thread will sleep for about 1/15th of a second. The method then moves to decision operation 178 where it is determined if the stream is ended. If the stream is not ended, the method returns to operation 170 to obtain the next access unit it proceeds as described above. If the stream has ended, the method terminates. TABLE 2 illustrates psuedo code that is alternatively illustrated by the flowchart of FIG. 6.

TABLE 2

```
While (stream has not ended) do
    Get the next AU (from the RT's buffer)
    Decode and display
    Sleep for a time determined by the play rate
```

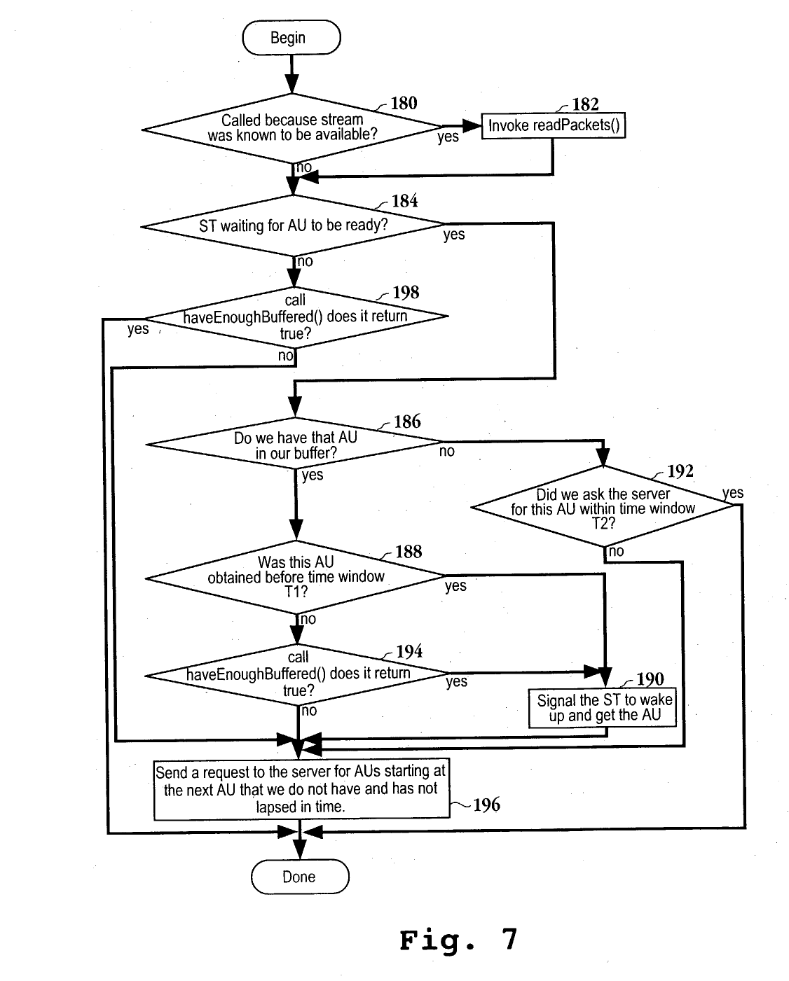

FIG. 7 is a flow chart diagram illustrating the method operations for a process function invoked periodically by the reader-thread in accordance with one embodiment of the invention. In one embodiment, the periodicity of invocation of the process( ) function is set to 200 milliseconds. It should be appreciated that the process function described below may also be invoked at other times when the network layer detects an incoming packet. The process function uses two helper functions called read-packet function and have-enough-buffered function. The annotated pseudo code for each of these functions is presented in Tables 3 through 5. Table 3 provides the psuedo code for the helper function referred to as the readpacket ( ) function. Table 4 provides the psuedo code for the helper function referred to as the haveEnoughBuffered ( ) function. Table 5 provides the psuedo code for the helper function referred to as the process ( ) function. An alternative illustration of the psuedo code for the process ( ) function is described with reference to FIG. 7.

```
TABLE 3
readPacket ( )
{
    while (true) {
        Read a packet from the network: if packet not available then
        break from the loop and return
        Parse the packet
        If CLOSE packet then set a flag to inform the RT and break
        from the loop
        It is an AU packet
        For each AU in the packet
            Copy the AU into the RT's buffer, note the time
            at which this AU has been obtained}
```

```
TABLE 4
haveEnoughBuffered ( )
{
        If we are using B buffer slots for AUs, and if the buffer
        occupancy (i.e., available AUs) starting from the next-needed
        AU is at least (preferBuffering * B/200), then return true, else
        return false.
}
```

```
TABLE 5
process ( )
{
    If this was called because data was known to be available for
        reading then call readPacket ( )
    If the ST is waiting for an AU to be ready
        If we now do have the AU in our buffer
            If the AU was obtained before time T1 (an algorithm
            parameter) or if haveEnoughBuffered ( ) then
                Signal the ST to wake up and get the AU
        If we do not have the AU but we asked for it recently from
        the server by sending a SEND packet recently enough
        (parameter T2) then return
    else
        there is no urgency
        if haveEnoughBuffered ( ) then return
    At this point, send a request: either the ST is waiting for an AU
    or our buffer is quite empty
    Create a SEND packet for requesting AUs starting at the next
    AU number that we do not have and has not lapsed in time.
    Also indicate how many AU buffer slots are free.
    Indicate in the SEND packet the AUs that we already have as best
    as possible using [skip-seq-num numToSkip] * lines. For example,
    if we are requesting AUs starting at number 50, but we already
    have AUs 51-57 and 64-68 in our buffers (this could happen
    because of lost packets), then the skip lines would be:
    51 7
    64 5
    If the available AUs are too fragmented (requiring very long skip
    lists to indicate them all), the client simply chooses to trim
    the skip list at the end.
    Send the SEND packet to the server.
}
```

It should be appreciated that the clients behavior can be modified altering some of the parameters provided in TABLES 3, 4, and 5. The parameter of B, used in the psuedo code for the haveEnoughBuffered ( ) function, represents the number of buffer slots of the client. In one embodiment, there is one buffer slot for each access unit (AU). In another embodiment, B equals 32. The parameter preferBuffering is a percent indicator of when to display video data or bring in and buffer more video data. Thus, the preferBuffering parameter acts as a buffer occupancy threshold and is used in the haveEnoughBuffered ( ) function. In one embodiment, the parameter T1 used in the process( ) function is set to be half the time between frames of the image. Parameter T2 represents the time the client is willing to wait for a requested AU to arrive before sending another request. In one embodiment, T2 is set to be a dynamic amount of time equal to the time it takes for three successive invocations of the process( ) function, either periodic or because an incoming packet was detected.

In one embodiment, the readpacket ( ) function is configured to essentially drain whatever data is available on the connection side. That is, the readpacket ( ) function reads from the network connection, e.g., the network I/O of FIG. 5, and places whatever data is read into appropriate slots in the buffer. The process function is called at the network layer through a socket. In one embodiment, an event, such as having data to be read, associated with that socket triggers calling the process function. It should be appreciated that the event may be communicated to the process function through a flag. That is, when the process( ) function is called, the process( ) funcltion would know whether it was called because of periodic invocation or because data was known to be available through the flag. This flag information is used in decision operation 180 in FIG. 7.

The method of FIG. 7 initiates with decision operation 180 where it is determined if the data was called because the data was known to be available. If the data was called because the data was known to be available then the method advances to operation 182 where the read packet function is invoked. For example, the data is available in a buffer of the client, therefore, the readpacket ( ) function will copy and read the data. If the data was not called because the data was known to be available, then the method advances to decision operation 184 where it is determined if the scheduled-thread is waiting for an access unit to be ready. If the scheduled-thread is waiting for an access unit to be ready in decision operation 184, then the method advances to decision operation 186 where it is determined if the access unit is in the buffer. If the access unit is in the buffer, then the method moves to decision operation 188 where it is determined if the access unit was obtained before a window time T1. If the access unit was obtained before window time T1, the method advances to operation 190 where the scheduled-thread is signaled to wake up and get the access unit.

The method of FIG. 7 then proceeds to operation 196 where a request is sent to the server for at least one access unit starting at the next access unit that the client does not have and has not lapsed in time. Here, the client may indicate how many buffer slots are free in one embodiment. In another embodiment, the client will indicate how many access units beyond the starting sequence that the client already has. That is, a skip list may be included here. For example, the SEND packet of TABLE 1 would include this data when transmitted to the server. Thus, the client maintains its own state rather than the server maintaining the state. Returning to decision operation 188 if the access unit was not obtained for time window T1, then the method proceeds to decision operation 194 where it is determined if the have-enough-buffered function returns a true value. If the have-enough-buffered function returns a true value, then the method moves to operation 190 where the scheduled-thread is signaled to wake up and get the access unit. The method then proceeds as described above from operation 190. Returning to decision operation 186, if it is determined that the access unit is not in the buffer, then the method proceeds to decision operation 192. In decision operation 192, it is determined if the client asked the server for the particular access unit within time window T2. If the server did not ask for the access unit within time window T2, the method advances to operation 196 and proceeds as described above. If the client did ask for the access unit within the time window T2, the method terminates, i.e., the client waits for the access unit to be received. Returning to decision operation 184, if the scheduled-thread is not waiting for an access unit to be ready, the method advances to decision operation 198 where it is determined if the have-enough-buffered function returns a value of true. If the have-enough-buffered function returns a value of true, then the method terminates. If the have-enough-buffered function does not return a value of true, the method advances to operation 196 and proceeds as described above. It should be appreciated that FIG. 7 graphically illustrates the psuedo code of TABLE 5.

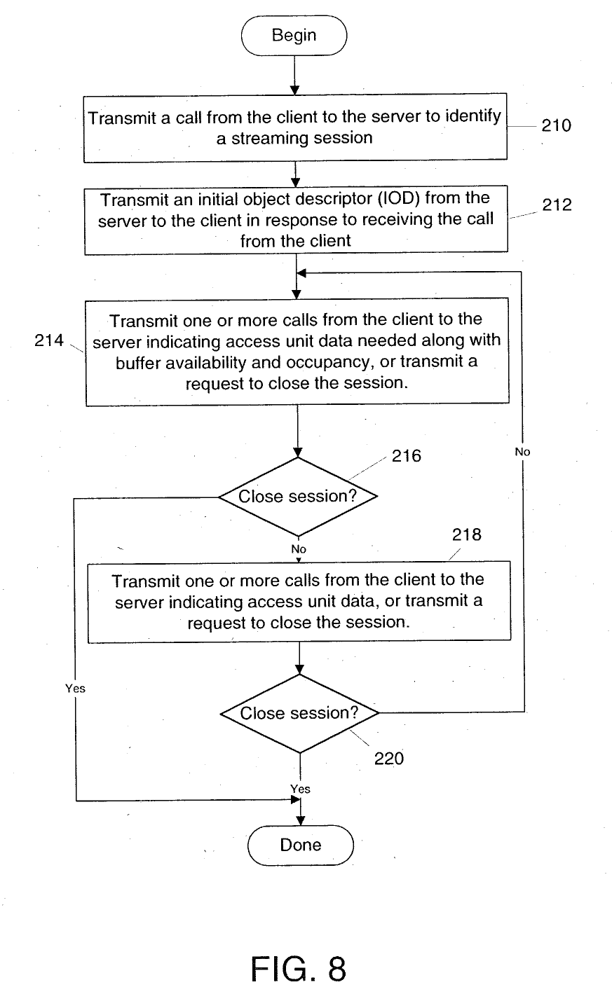

FIG. 8 is a flow chart diagram illustrating the method operations for communicating video/audio data from a server to a client in accordance with one embodiment of the invention. The method initiates with operation 210 where a call from the client to the server is transmitted to identify the streaming session. Here, the call from the client to the server is configured as an OPEN packet described above. The method then advances to operation 212 where an initial object descriptor (IOD) packet is transmitted from the server to the client in response to receiving the call from the client. As described above, the initial object descriptor packet has data beginning at a fixed offset and the data is content-specific. In one embodiment, the IOD packet includes information that describes a set of elementary streams, and also conveys the set of profile and level information that is needed by the client to assess the processing resources needed for that content. The method then proceeds to operation 214 where one or more calls from the client are transmitted to the server. Here, the calls to the server from the client may indicate the access unit data needed along with the buffer availability and occupancy. Alternatively, a request to close the session, i.e., a close packet, may be transmitted from the client to the server.

The method of FIG. 8, then moves to decision operation 216 where it is determined if a request to close the session was transmitted from the client to the server. If a request to close the session was transmitted, then the method terminates as the session is closed. If a request to close the session was not transmitted then the method advances to operation 218 where one or more calls from the client are transmitted to the server. As in operation 214, the calls to the server from the client may indicate the access unit data needed along with the buffer availability and occupancy. Alternatively, a request to close the session, i.e., a close packet, may be transmitted from the client to the server. The method then proceeds to decision operation 220 where it is determined if a request to close the session was transmitted from the client to the server. If a request to close the session was transmitted, then the method terminates as the session is closed. If a request to close the session was not transmitted, then the method returns to operation 214 and repeats as described above. It should be appreciated that the client initiates the data transfer. In one embodiment, the client initiates data transfer by transmitting a SEND packet to the server indicating the AUs needed by the client along with buffer occupancy and availability information as described above. In another embodiment, audio/video data is sent inside AU packets from the server to the client.

The client may be configured to provide fast forward and/or fast rewind functionality. Here, the Intra (I) frames, not the predicted (P) frames and bi-directional (B) frames, are only shown for the fast forward or fast rewind functionality. Since the client does not have the information to tell which frames are I frames, the client will request the information from the server. For example, the client may send a packet asking the server for a list of I frame numbers. The server then responds and provides the list of I frame numbers or a 1^{st} I frame number and a periodicity of the I frames. The client request my be referred to as a summary request packet and the server response may be referred to as a summary response packet. Thus, the summary request packet and the summary response packet are two more additional types of packets that may be added to the types of packets described in TABLE 1.

In summary, the above described invention describes a client server relationship for the exchange of video/audio data through a simplified communication protocol. The communication protocol is tailored to accommodate the characteristics of wireless networking and the associated devices. That is, the system is built on top of a non-guaranteed delivery lower level protocol, such as UDP. The small video dimensions characteristic of the display screens provided with the handheld electronic devices are also accommodated. For example, the quarter common intermediate format (QCIF) having 176 pixels by 144 lines and the common intermediate format (CIF) having 352 pixels by 288 lines are typically used for the display screens on the handheld electronic devices described above. Multiple access units (containing one frame of data each) of such low bit-rate and low-resolution video may fit inside a single UDP packet. The configuration of the system discussed above exploits this feature by allowing the client to lump together multiple requests and the server to lump together multiple responses within a single UDP packet. Accordingly, networking overheads and fragmented memory accesses are minimized, thereby reducing power consumption. In one embodiment, the clients, i.e., handheld electronic devices, are power scalable. That is, as the power available from the batteries of the handheld devices decreases, the video decoders of the devices switch to video decoding profiles consuming less power. For more detailed information on power scalability of the video decoder please refer to U.S. patent application Ser. No. 10/360,977, filed on Feb. 7, 2003 and entitled “POWER SCALABLE DIGITAL VIDEO DECODING.” This application is hereby incorporated by reference in its entirety.

It should be appreciated that the system and communication protocol described herein are targeted for low bit rate, i.e., less than 128 kilobits per second. However, the embodiments described above may be applied to higher bit rates. It should be further appreciated that the above described embodiments may be implemented in software or hardware. For a software implementation, the reader-thread and the scheduled-thread modules may be implemented as separate threads running concurrently. For hardware implementations, the reader-thread and the scheduled-thread modules may be implemented using control logic that enables the reader-thread and the scheduled-thread modules to run in parallel.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A system configured to support multimedia streaming, comprising:
a client, the client associated with a reader-thread component and a scheduled-thread component, the reader-thread component associated with a buffer for storing data received by the client, the reader-thread component further configured to perform network input/output functionality, the scheduled-thread component enabling decoding and displaying a multimedia stream of data, the scheduled-thread component further configured to obtain access units from the buffer; and
a server in communication with the client through a network, the server configured to transmit access units specified by the client to the client.

2. The system of claim 1, wherein the reader-thread component is configured to initiate data transfer to the client by transmitting a send packet to the server.

3. The system of claim 2, wherein the send packet includes a start sequence number indicating a frame of image data, a requested number of frames of image data subsequent to the start sequence number to be sent to the client, and a skip-list indicated frames of image data within the requested number of frames that the client has stored.

4. The system of claim 1, wherein the client is a wireless handheld device enabled for power scalability, the power scalability causing a video quality to degrade as power available for the wireless handheld device decreases.

5. The system of claim 1, wherein the access units are contained within packets configured to be transmitted over the network through a user datagram protocol (UDP).

6. A system for streaming digital video/audio data, comprising:
a client configured to maintain a state of the client;
a server in communication with the client through a network,
a User Datagram Protocol (UDP) enabling communication between the client and the server through the network, the UDP protocol defining a packet configured to hold at least one access unit (AU), each of the at least one AU representing one frame of video/audio data, the one frame of video/audio data being transmitted to the client from the server, the transmission of the one frame of data being initiated by transmission of a send packet from the client to the server based upon the state maintained by the client, wherein in response to receiving the send packet, the server transmits the one frame of video data specified in the send packet.

7. The system of claim 6, wherein the state of the client includes data associated with a starting frame of video/audio data needed by the client, data associated with a sequence of video/audio data from the starting frame, and data associated with portions of the sequence of video/audio data that the client has stored.

8. The system of claim 6, wherein the client and the server communicate through a wireless network.

9. The system of claim 6, wherein the packet is formatted with null terminated lines.

10. A client capable of displaying received video data, comprising:
a network input/output (IO) component configured to receive video data and transmit requests for video data to a server;
a scheduled-thread component configured to decode and display the video data; and
a reader-thread component configured to obtain the video data through the network IO, the reader-thread component further configured to supply the scheduled-thread component with the received video data from a buffer associated with the reader-thread component.

11. The client of claim 10, wherein the reader-thread component invokes a process function to obtain the video data.

12. The client of claim 11, wherein the process function determines whether the video data is in the buffer.

13. The client of claim 10, wherein the reader-thread component calls a helper function to request data, the helper function specifying a starting point and an amount of data requested for the client.

14. The client of claim 10, wherein the reader-thread component calls a helper function to read data stored in the buffer.

15. A method for communicating video/audio data from a server to a client, comprising:
transmitting a call from the client to the server to identify a streaming session;
in response to receiving the call from the client, transmitting an initial object descriptor (IOD) from the server to the client;
initiating data transfer in response to receiving the IOD, the initiating including,
communicating data indicating both a start sequence of streaming session data and an amount of the streaming session data to the server, the start sequence and the amount being determined by the client; and
responding to the receipt of the data indicating the start sequence and the amount of the streaming session data by supplying the client with access units containing the video/audio data.

16. The method of claim 15, wherein the method operation of initiating data transfer in response to receiving the IOD includes,
invoking a process function;
determining if needed streaming session data is available in a buffer associated with the client;
if the needed streaming session data is not available, then the method includes sending a request for the needed streaming session data.

17. The method of claim 15, wherein the call is an OPEN packet indicating a session identification and a streaming session name.

18. The method of claim 15 wherein, the IOD specifies a set of profile and level information needed by the client to assess the processing resources needed for the streaming session.

19. The method of claim 15, wherein a SEND packet is used by the client to communicate the start sequence and the amount of streaming session data to the server.

20. The method of claim 19, wherein the SEND packet includes a skip list, the skip list indicating a portion of the streaming session data the client has access to.

21. The method of claim 15, wherein the access units are transmitted to the client from the server in packets each packet containing one or more access units, each access unit corresponding to a single frame of video/audio data of the streaming session.

22. The method of claim 15 wherein, the system is built over a User Datagram Protocol.

23. The method of claim 16, wherein the process function is invoked periodically by a reader-thread associated with the client.

24. The method of claim 16, wherein the process function determines if the access units are available within a buffer associated with the client; and
if the access units are available, then the method includes reading the access units from one of a buffer associated with the client and a network connection;
if the access units are not available, then the method includes determining if a buffer occupancy threshold has been exceeded, wherein if the buffer occupancy threshold has been exceeded a request is sent to the server from the client for additional access units.

25. The method of claim 24, wherein if the buffer occupancy threshold has not been exceeded, then the client waits for the access units to become available.

26. A computer readable medium having program instructions for communicating video/audio data from a server to a client, comprising:
program instructions for transmitting a call from the client to the server to identify a streaming session;
program instructions for transmitting an initial object descriptor (IOD) from the server to the client in response to receiving the call from the client;
program instructions for initiating data transfer in response to receiving the IOD, the program instructions for initiating including,
program instructions for communicating data indicating both a start sequence of streaming session data and an amount of the streaming session data to the server, the start sequence and the amount being determined by the client; and
program instructions for responding to the receipt of the data indicating the start sequence and the amount of the streaming session data by supplying the client with access units containing the video/audio data.

27. The computer readable medium of claim 26, wherein the program instructions for initiating data transfer in response to receiving the IOD includes,
program instructions for invoking a process function;
program instructions for determining if needed streaming session data is available in a buffer associated with the client; and
program instructions for sending a request for the needed streaming session data if the needed streaming session data is not available.

28. The computer readable medium of claim 27, wherein the program instructions for invoking the process function are invoked periodically by a reader-thread associated with the client.

29. The computer readable medium of claim 27, wherein the program instructions for the process function determines if the access units are available within a buffer associated with the client.

30. The computer readable medium of claim 29, further comprising:
program instructions for reading the access units from one of a buffer associated with the client and a network connection if the access units are available; and
program instructions for determining if a buffer occupancy threshold has been exceeded if the access units are not available, wherein if the buffer occupancy threshold has been exceeded, program instructions for requesting additional access units from the server are executed.
